(19) United States
(12) Patent Application Publication
(10) Pub. No.: US 2002/0016727 A1
(43) Pub. Date: Feb. 7, 2002

(54) Systems and methods for interactive innovation marketplace

(75) Inventors: W. Radford Harrell, Des Moines, IA (US); James R. Humphries JR., Woodstock, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: ThoughtBank, Inc.

(21) Appl. No.: 09/884,609

(22) Filed: Jun. 18, 2001

Related U.S. Application Data
(60) Provisional application No. 60/212,175, filed on Jun. 16, 2000.

(51) Int. Cl. G06F 17/60

(52) U.S. Cl. 705/7

(57) ABSTRACT

A system is provided for dynamically matching knowledge capital with developers capable of developing the knowledge capital. The system comprises an innovator interface, a developer interface, and an innovation marketplace server communicatively connected via a network. The innovation marketplace server receives knowledge capital information defining innovation profiles from the innovator interface and divides each the innovation profiles into at least two sub-profiles comprising a first and second level of information. The sub-profiles are stored in a database which is then searched to determine if one or more of the first sub-profiles matches a search criteria defined by information received from the developer interface. In response to a match, the innovation marketplace server displays the first sub-profile and provides the developer interface with access to the second sub-profile corresponding to the first sub-profile in response to the satisfaction of an access barrier based on input received from the developer interface.

### FIELD OF THE INVENTION

The present invention relates to interactive, networked marketplaces. More particularly, the invention relates to an interactive marketplace that facilitates the development of knowledge capital.

### BACKGROUND OF THE INVENTION

Creating, nurturing, protecting, and marketing innovative knowledge capital (often consisting of ideas, concepts and innovations) and intellectual property is a key to success in any industry. An inventor's most important assets are his/her IP rights, which may include various patents, trademarks, copyrights and trade secrets. The process of protecting these assets, however, is often complex. Most inventors take painstaking efforts and precautions to nurture and develop their ideas, yet often fail to take the same precautions with their inventions once they are developed and released to market, allowing these valuable assets to go unprotected and unmanaged.

One of the biggest problems impeding innovation is the lack of an organized process for developing and marketing innovations. Large companies have long implemented their own internal systems for developing, protecting, and marketing innovations, but smaller companies and individuals are commonly unaware of the procedures involved and are typically at the mercy of large companies when trying to market their innovations. Moreover, individuals practicing in a particular field are often the best source for information and innovation related to that field. For example, medical practitioners are often a valuable source of potential innovation in the area of medical products. However, individual practitioners may be intimidated by the development process. As a result, practitioners often volunteer their ideas to large companies who then develop and market the ideas for their own profit without compensating the practitioner that had the idea in the first place. The ability to recognize and protect intellectual property is paramount for inventors, especially when these ideas are communicated electronically. In the digital era of the Internet, authenticating and time/date stamping electronic media is a must for any IP that is transmitted electronically between entities. For the IP of an inventor to be properly protected, a certifying authority that brokers the transaction of transmitting IP electronically between trading partners is needed.

With the advent of the Internet, several Internet web sites have attempted to provide a marketplace for intellectual property. These sites, however, focus on intellectual property that has already been protected such as existing patented technology or the like. One disadvantage of these sites is that smaller companies and individuals must seek protection for their innovations prior to seeking a market for those innovation. This may lead to unnecessary expense if the innovator is unable to find a market for their innovation. In addition, as stated above, many individuals and smaller companies are unfamiliar with the procedures required to protect and market their innovations and are thus intimidated by the process. The process for protecting these ideas becomes an expensive proposition for an individual inventor, whereby a common marketplace would make this process much more cost efficient due to economies of scale. This marketplace would also benefit businesses seeking to exploit IP by offering them a collective market of innovations.

Therefore, there is a need for an innovation marketplace that provides an efficient and easy-to-use means for marketing innovations while protecting the innovator's rights in the innovation. There is also a need for an innovation marketplace that guides innovators through the development and marketing of their innovations and provides product developers with a means for locating new innovations suited to their development needs and capabilities.

### SUMMARY OF THE INVENTION

The present invention, as described herein, comprises methods and systems for implementing an innovation marketplace that enables innovators to further develop and market innovations without necessitating that the innovator first seek protection of their rights. The present invention also enables developers to access the system to search for innovations suited to their development needs and capabilities.

According to one embodiment of the present invention, an innovation marketplace is provided comprising an innovator interface, a developer interface, and an innovation marketplace server, each of which is communicatively connected to a network. Using this marketplace a system and method for dynamically matching knowledge capital with developers capable of developing the knowledge capital is provided. According to one embodiment of the present invention, knowledge capital information defining a plurality of innovation profiles is received from at least two innovator interfaces. Each of the innovation profiles are into at least two sub-profiles wherein a first sub-profile comprises a first level of information and a second sub-profile comprises a second level of information and the sub-profiles are stored in a database. In a preferred embodiment, the first and second sub-profiles are stored in separate databases. Using the innovation marketplace server, the database is searched to determine if one or more of the first sub-profiles matches a predefined search criteria, preferably provided by a developer using the developer interface. In response to a match, at least one first sub-profile is displayed to the developer using the developer interface and the developer is given the option to access the second sub-profile corresponding to the at least one first sub-profile in response to the satisfaction of an access barrier.

In a preferred embodiment, the knowledge capital information received by the innovation marketplace server comprises information identifying an innovator of the knowledge capital and the identify may be verified using information obtained from a database remote from the innovation marketplace server. According to another aspect of the present invention, the knowledge capital received via the innovator interface further comprises a time and date stamp associated with the knowledge capital information which indicates the date and time the knowledge capital information was received. Additional knowledge capital information may also be added to the innovation profile at a later date and a date and time stamp may be associated with the added information to provide an accurate record of when the knowledge capital information was received by the innovation marketplace server. Further, the innovation profiles may be stored in more than one location to provide a backup record of the information and protect the integrity of the information. Moreover, the received knowledge capital may be associated with a unique digital signature indicating the author of the knowledge capital information.

Other features and advantages of the present invention will become apparent to one skilled in the art upon examination of the following drawings and detailed description. It is intended that all such features and advantages be included herein within the scope of the present invention.

### BRIEF DESCRIPTION OF THE DRAWINGS

FIG. 1 is a high-level representation of one possible embodiment of the present invention.

FIG. 2 is a schematic illustration of a server according to one possible embodiment of the invention.

FIG. 3 is a flow-chart illustrating a possible innovator login and registration procedure according to one aspect of the present invention.

FIG. 4 is a flow-chart illustrating a possible procedure for creating an innovation profile according to one aspect of the present invention.

FIG. 5 is a flow-chart illustrating a possible developer login and registration procedure according to one aspect of the present invention.

FIGS. 6A-6B are flow-charts illustrating a possible method for locating and viewing an innovation profile according to one aspect of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

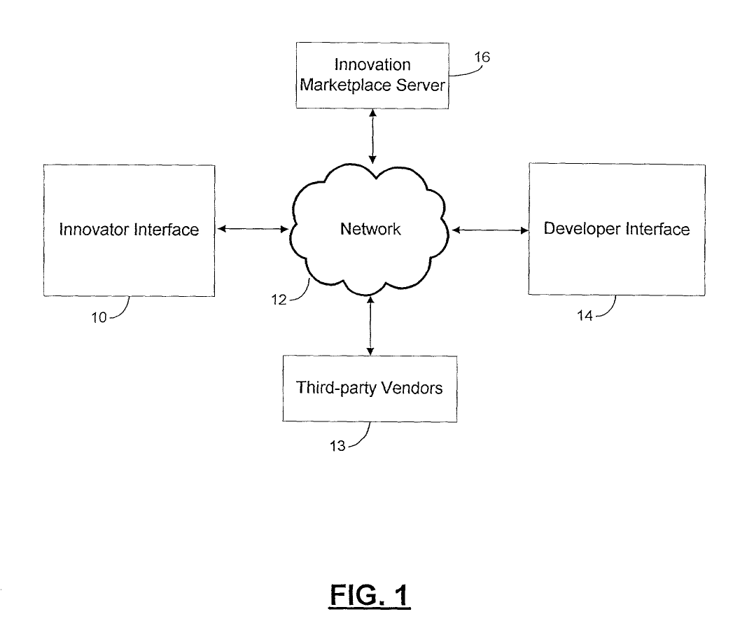

The present invention is generally directed towards implementing an online innovation marketplace that facilitates the development and transfer of knowledge capital between innovators and developers. For purposes of this application, knowledge capital comprises any ideas, know-how, improvements, concepts business models, innovations, inventions or the like that may have value in a particular industry. FIG. 1 shows a high-level representation of the invention. As shown generally in FIG. 1, the present invention comprises of an innovation marketplace server 16 that may be accessed by innovators through an innovator interface 10 and by product developers through a developer interface 14 through a secure connection to a network 12.

The innovators that may access the innovator interfaces 10 may comprise any individuals or companies that have an idea for an innovation in a particular field of endeavor or industry such as medical practitioners, engineers, independent inventors, or companies that employ such individuals and wish to develop the ideas of the individuals they employ. The developers that may access the developer interface 14 may be any individual or company that has the capability and/or desire to develop and market third-party innovations. The network 12 may be any network with sufficient connectivity to enable communication between the developer interface 14, the innovator interface 14, and the innovation marketplace server 16 such as the Internet, a local area network, or a wide area network.

The innovation marketplace server 16 is preferably a computer with sufficient resources to support access by a plurality of developers and innovators. According to one possible embodiment of the present invention, the server is a computer comprising a 32-bit ×86 processor, a hard disk with 128 megabytes (MB) or more of free space, a network interface card, a CD-ROM drive, 32 MB or more of random access memory (RAM) that may be expanded to accommodate access by additional innovators and developers, a mouse, a keyboard, and a monitor. It will be appreciated, however, that this system is provided merely for illustrative purposes. The server may also be a unix-based system such as the Sparcstation provided by Sun Microsystems or any other computer system with sufficient resources to provide the functionality as described herein.

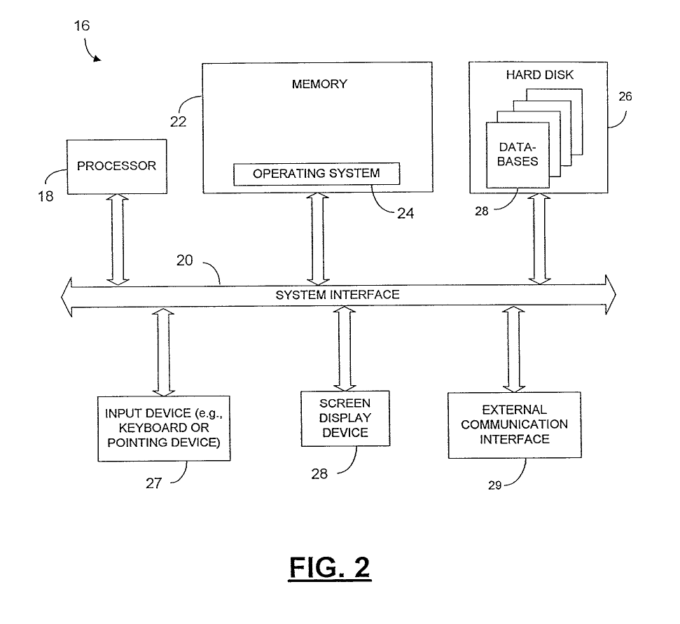

Turning now to FIG. 2, there is a shown a schematic diagram representing the functional components of an innovation marketplace server 16 according to the present invention. The server 16 may comprise a processor 18, a memory 22, and a hard disk 26 communicatively connected to a system interface 20. The system interface 20 is also preferably connected to an input device 27, a display device 28 and an external communication interface 29. The memory 22 preferably comprises an operating system 24 and software to facilitate server operation and communication with the innovator interface 10, network 12, and developer interface 14. The memory may also comprise program logic to implementing one of more of the features described below. The hard disk 26 preferably contains memory sufficient to store information concerning the innovators and developers as well as a plurality of innovations. In addition, the hard disk 26 may contain one or more searchable databases that store profile information for the innovators, developers, and innovations. Alternatively, one or more databases may be located remote from the innovation marketplace server in a separate server or storage device in communication with the innovation marketplace server. The system interface 20 may be a computer bus that facilitates the exchange of information between the components of the server. The input device 27 may be a keyboard, mouse, etc. that allows information to be input into the server. The screen display device 28 enables information to be displayed to a user. The external communication interface 29 facilitates communication between the innovation marketplace server and the network 12. The particular configuration of the innovation marketplace server is not important so long as the server contains sufficient resources to implement the functionality of the innovation marketplace as described herein. In general terms, the innovation marketplace facilitates the development of knowledge capital via an electronic marketplace that defines multiple methods of developing an idea from innovation to market using a series of “idea maps” that define a transactional engine for dynamically matching knowledge capital with entities capable of developing the knowledge capital and bringing it to market.

The innovator interface 10 may be any device capable of communicating with the network 12 to exchange information with the innovation marketplace server 12 such as a computer, a PDA, a telephone, or any other messaging or communication device. In a preferred embodiment, the innovator interface comprises a computer communicatively connected to the Internet (which may serve as the network 12). Preferably, the innovator interface also comprises a graphical user interface, such as an Internet web browser, that is capable of receiving and displaying Internet web pages to the innovator. The following discussion describes the functionality of the innovation marketplace using the above embodiment. It will be appreciated, however, that any of numerous innovator interfaces may be employed without altering the novel aspects of the present invention.

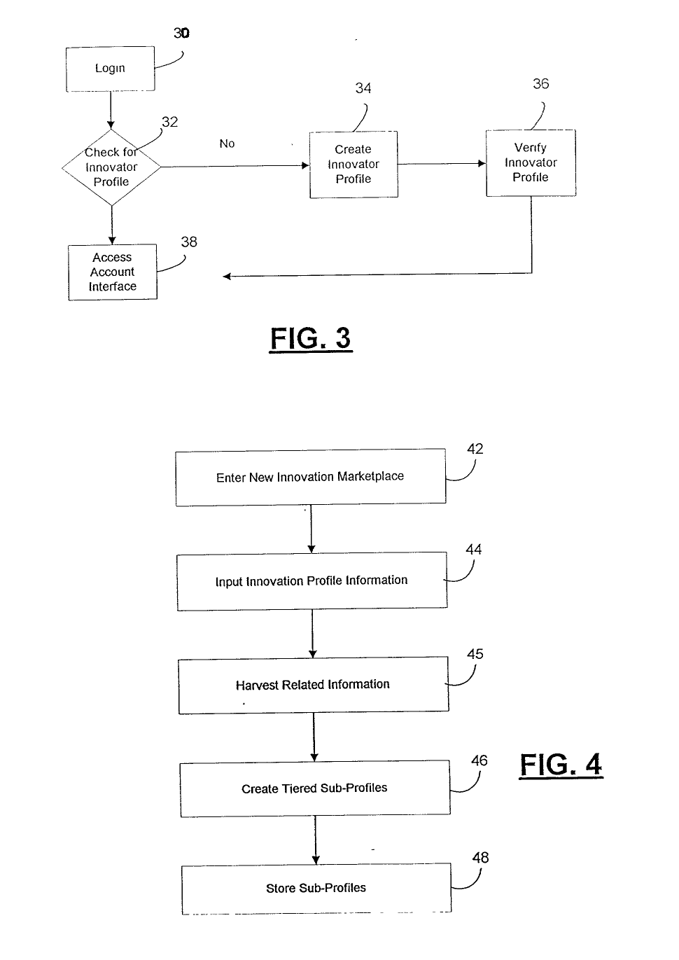

FIG. 3 shows an overview of the process by which an innovator may gain access to the innovation marketplace. As shown in block 30, the innovator may gain access to the innovation marketplace by first logging into the innovation marketplace server by inputting information into the innovator interface 10. Preferably, the innovator uses the innovator interface 10 to connect to an Internet web site that is hosted by the innovation marketplace server. In this embodiment, the innovator is presented with a login screen that enables the innovator to either login to the system using previously assigned login information or to create a new innovator profile and receive unique login information corresponding to the respective innovator profile.

If the innovator has not yet established an innovator profile, the innovator may be presented with a short tutorial outlining the operation of the innovation marketplace. The innovator may also be asked to enter into a legal agreement with the innovation marketplace under which the innovator agrees to certain conditions regarding its use of the innovation marketplace and the dissemination of the innovations contained therein. Preferably, the innovator's rights and obligations under the agreement will be explained to the innovator and the innovator will be required to enter into the agreement before being allowed to create an innovator profile. Alternatively, the innovator may be granted access to the innovation marketplace without having entered into the agreement, but the services that it is allowed to use may be restricted. The purpose of the legal agreement is to ensure that members of the innovation marketplace do not misuse the information contained therein.

After the tutorial and agreement, the innovator may establish an innovator profile as shown in block 34. The innovator profile may serve a dual purpose. First, the innovator profile is used by the innovation marketplace to facilitate matching the innovators knowledge capital with a suitable product developer. Second, it allows the innovation marketplace server to ensure that the innovators using the system are actually qualified in their field of expertise and that the information provided by the innovator is accurate. The profile may also serve an additional purpose by identifying certain individuals who are suited for particular projects. This is achieved using a unique profile and verification system that not only establishes the innovators credentials but also verifies that those credentials are authentic. As is described in detail below, the innovator profile may be used to target innovators for application/expertise specific opportunities that may be offered by product developers. The innovator profile may also be used to target advertising to specific innovators interested in specific product offerings or associated with a particular field.

In a preferred embodiment, the innovator profile is compiled by presenting the innovator, via the innovator interface, with a fillable template containing a plurality of fields that may filled in with information concerning the innovators background, personal identity, credentials, awards, degrees, or any other information that is relevant to the particular field of innovation and/or the inventor. After filling in the form, the innovator may submit the form to the innovation marketplace server 16 over the network 12. For example, if the innovator is a medical practitioner, the profile information will request information concerning the practitioners board certifications, continuing education credits and information, academic background, publications, etc. A significant feature of the present invention is that the innovator profile is maintained in a secure database that is not available to the general public or to other participants in the innovation marketplace. The information is used only internally by the administrators/operators of the innovation marketplace to maintain the integrity of the system and facilitate the secure, protected transfer and/or development of knowledge capital.

After the innovator has entered their profile information, the innovation marketplace server verifies the accuracy of the information, as shown in block 36. The verification process will vary depending on the industry or field of the innovator. Preferably, the innovation marketplace server will interact with third-party vendors (shown as block 13 in FIG. 1) and information databases to verify the accuracy of the innovator profile. For example, in the medical industry, the verification system may communicate with databases maintained by the American Medical Association or other independent databases that store information about particular individuals (or practitioners) in the medical field to determine whether the information contained in the innovator profile is accurate. A number of such databases may be used to verify some or all of the information included in the innovator profile. If the information contained in the innovator profile is inaccurate, the innovation marketplace server may notify the inventor of the inaccuracy and request that the information be corrected and/or supplemented. Notification may be accomplished by transmitting a message to the innovator interface using any of numerous messaging mean well-known in the art. In a preferred embodiment, the innovation marketplace server notifies the innovator by electronic mail or by posting a message to their account. It will be appreciated that certain industries may not contain third-party databases with sufficient information to verify the accuracy of the innovator profile. In such situations, the innovation marketplace server simply indicate which information is verified and which parts were unverified.

Once an innovator profile is created, the innovation marketplace server 16 may store the innovator profile in a secure database located in the hard-disk 26 or some other database server communicatively connected to the innovation marketplace server 16 and the innovation marketplace server 16 issues a secure username and password to the innovator to be used for future access. It will be appreciated, however, that the innovator may also be given the option of creating their own username and/or password.

After the innovator profile has been verified, the innovator is then provided with access to the innovation marketplace by way of a unique innovator account interface as illustrated by block 38 of FIG. 3. The innovator account interface is preferably an Internet web page unique to each innovator that displays various information relevant to the innovator. The innovator account interface may display various information concerning the innovator's account such as: a summary of the innovator's profile; information concerning the innovator' industry and industry related updates and current events; information concerning the operation of the innovation marketplace and tips for using the system successfully; information concerning recent innovation trends in particular industries, information concerning the innovations and/or knowledge capital entered into the innovation marketplace by the respective innovator (hereinafter referred to as innovation profiles); statistical information concerning the innovation marketplace such as the number of users currently logged into the system, the number of successful transactions facilitated by the system, and the latest news concerning updates and advances to the system; and information relating to innovator opportunities such as targeted advertisements, requests for participation in market research or product development or any other opportunities that may be of interest to the innovator. In addition, the innovator interface will preferably provide the inventor with access to the services offered by the innovation marketplace such as the new innovation marketplace, survey participation opportunities, existing product refinement services, and ancillary innovation development services. It will be appreciated that the information provided via the innovator account interface may be adapted to meet the demands of particular industries. Thus, the above listing is purely exemplary and is not intended to limit the possible universe of information and/or data that may be made available through the innovator interface.

The New Innovation Marketplace (Innovator-side)

A significant feature of the present invention is the new innovation marketplace that enables innovators to market and develop new innovations. The new innovation marketplace enables the innovator to create new innovation profiles that are presented to potential developers in a protected format. The innovation profile is a dynamic record that is created for the knowledge capital that the innovator desires to market such as a new invention or innovation in a particular area. Ideally, the innovation profile contains information identifying a particular need in a specified market and information concerning a possible solution to that need. An innovation profile may be created for any type of knowledge capital such as ideas, inventions, new business models etc. The actual information contained in the innovation profile may vary according to the type of knowledge capital being entered.

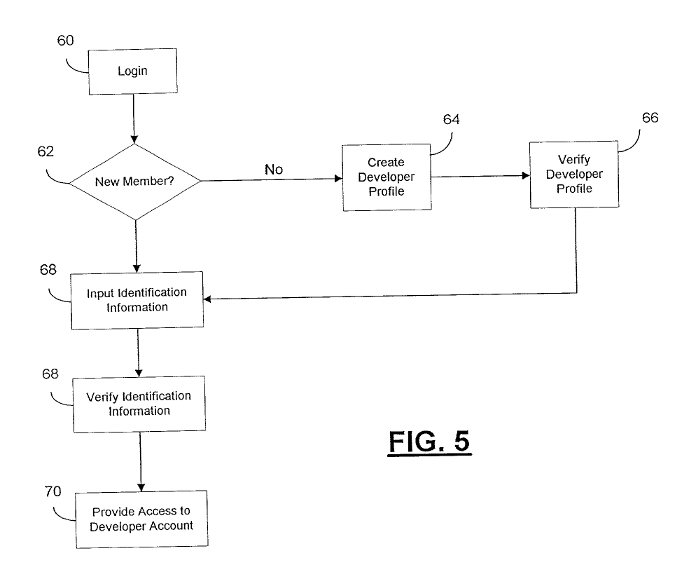

The innovation profile may be constructed using a method similar to that discussed above with reference to the creation of the innovator profile. As shown in block 42 of FIG. 4, the innovator must first enter the new innovation marketplace. Preferably, the inventor may gain access via the innovator's account interface. In a preferred embodiment, the innovation marketplace server transmits a fillable Internet web page form to the innovator interface. The web page preferably contains a series of fields requesting information from the innovator relating to the particular type of knowledge capital for which the innovation profile is being created. It will be appreciated that a series of menus and/or forms may be presented to the innovator to narrow the field to which the innovation pertains and simplify the creation of the innovation profile.

As shown in block 44 of FIG. 4, the innovation profile is initially created using information input by the innovator. Using the innovator interface, the innovator may input information into the fillable form and transmit the information back to the innovation marketplace server for processing and storage. Preferably, the innovator is asked to define the type of knowledge capital involved, the market or markets for which it is useful, and the details of the knowledge capital itself. The innovator may also be asked (by including fields on the form) to provide information concerning: the market in which the knowledge capital may be used; the size of the market; the type and category of knowledge capital; a statement concerning the usefulness of the knowledge capital and/or the problem it is designed to remedy; the means by which the knowledge capital may be produced, examples of existing or related products that are similar to the knowledge capital; information concerning the stage of development of knowledge capital; etc. The innovator may also be asked to submit additional information concerning other innovations in the same field or how the knowledge capital was initially developed or discovered. If the knowledge capital is subject to regulations, the innovator may submit information pertaining to whether the knowledge capital is predicted to meet (or meets) regulatory standards or whether it has undergone testing. For example, for medical products, the innovator may submit information concerning the FDA clearance level or the status of clinical trials. The innovator may also be given the option of providing a narrative concerning the knowledge capital and/or the ability to submit drawings, sketches or the like further describing the knowledge capital and its uses. In addition, although the above description provides for creation of the innovator interface using fillable web page forms, other methods may also be employed such as manual entry by a customer service representative, presenting the innovator with a series of questions, etc.

Advantageously, the initial query serves as only the starting point for defining and developing the knowledge capital. Unlike other systems, the present invention does not require that the knowledge capital be fully developed. On the contrary, one aspect of the present invention is the ability to add value to the knowledge capital while in its early stages. For example, the innovation profile may initially contain only general information identifying a market need and a potential solution to that need. The innovator may then utilize the other features of the present invention to add value to the knowledge capital by further refining the innovation or by adding additional information to the innovation profile. Thus, although the knowledge capital may constitute an idea relating to a particular product, an innovation profile may be created regardless of the stage of development. It will be recognized that this enables innovators to market their ideas early in the development process, before significant time and expense have been invested.

After the innovator submits the information concerning the knowledge capital, the innovation marketplace server creates and stores an innovation profile for the knowledge capital. As shown in block 45 of FIG. 4, the innovation marketplace server will then employ an object-oriented, self-learning database structure to harvest additional information relating to the knowledge capital, potential markets for the knowledge capital, and potential development opportunities. This may be achieved using a “spider” program, as is well-known in the art, to mine third-party databases for market data, financial information, competing products, competitors and other information relevant to the innovation. This information is then compiled and automatically added to the innovation profile. Advantageously, the innovator is provided with additional information that may assist them in further developing the innovation profile and/or deciding on the best way to pursue their innovation. This value-added feature also provides an incentive to the innovators to be complete with their disclosures so that the invention can retrieve the most pertinent information from available third-party sources.

According to one aspect of the present invention, the innovator may be given the option of using the innovation profile to seek protection for the knowledge capital contained therein. Advantageously, the innovation profile already contains significant information concerning the innovation so much of the information needed to seek protection is already present in the innovation profile. If the innovator desires to pursue protection, program logic within the innovation marketplace server will preferably present the innovator with a interface (preferably an Internet web page), that requests any additional information needed to seek protection for the innovation. For example, if the innovation is a product invention, the innovator may be presented with a fillable form that contains questions relating to information necessary to complete an invention disclosure suitable for use as a provisional patent application.

In a preferred embodiment of the present invention program logic is used to ask the innovator multiple questions about the innovation and then funnels the answers into the innovation profile. In addition, program logic may also be provided to select specific questions based on the nature of the innovation. In particular, questions may be generated to help harvest information that companies require to evaluate to viability of a particular type of innovation. For example, if information of a particular innovation in the Food and Drug industry were to become unique, program logic could utilize the Food and Drug Administration's (FDA) information structure to identify where the innovation fits in the regulatory environment.

According to another aspect of the present invention, the innovation marketplace may provide innovators with access to in-depth information about the innovation/invention process. This information may include information concerning possible development paths for the invention including a description of the various features offered by the innovation marketplace and guidance as to what is involved in realizing potential value in an idea or invention. This information is preferably stored on one or more databases accessible by the innovation marketplace server. The databases also preferably include information concerning third parties that may be able to offer further assistance in the innovation process. Advantageously, these information databases provide a launching point to understanding the innovation process, understanding how the innovation marketplace adds value and what an innovator needs to know to make informed, cost-effective decisions about where to allocate their valuable resources of time, money and energy.

For example, bringing a new idea to market involves many steps, most of which should add value to the idea. Often, an innovator must encounter issues involving industrial design, creating a prototype, submitting a patent, generating a market assessment and many other complicated facets of the innovation process. Advantageously, the innovation marketplace may serve as a guide to assist the innovator in navigating through this process. According to one aspect of the present invention, the innovation marketplace provides the innovator with a dynamic listing of carefully screened service and product companies that provide specific functions during the development process. These companies could range from embryonic development functions such as prototype construction, industrial design, engineering, human factors studies or material consulting, to mature business functions such as funding, tax and CPA services, corporate formation or underwriting for an IPO. Preferably, all of the companies listed are fully screened and credentialed prior to being listed. The specific function they perform, where they fit in the development path, their pricing structure and the benefits to using them may all be provided to innovators to further assist in developing their innovations.

In addition, the innovation marketplace may automatically facilitate interaction between an innovator and one or more companies that facilitate the innovation process. According to one possible embodiment, the innovation marketplace server may automatically transmit information concerning an innovation or an innovator to a patent attorney. The patent attorney may, in turn, contact the innovators directly to inform them of the patent process and their options in seeking protection of the invention. Advantageously, this enables innovators who may be unfamiliar with the need for protection or the process by which protection is obtained to be sheparded through the process without having to seek out the information independently. According to this embodiment, the innovation profile may also be transmitted electronically to a third-party (or in-house) patent counsel. If the innovator elects to transmit their innovation profile electronically, the innovation marketplace may encrypt the document to ensure that the transmission is secure.

The innovation profile may also serve another important function because it enables the innovator to continually update their invention while maintaining a reliable and accurate record of the innovation and each addition thereto. The innovation marketplace server may also contain program logic that stores all of the innovator's changes and additions and records the dates (and times) on which each change or addition was made. Thus, the innovator may use the innovation profile as digital innovation notebook which serves as a time-stamped record of their innovation and tracks all of the improvements and changes thereto.

According to one aspect of the invention, an innovation certification process is provided by which an innovation document may be certified with a digital signature and timestamp, placed into a secured container (in either hard copy or electronic form), and distributed to two or more servers located at disparate locations. Preferably, a unique identifier for the innovation is included in the digital innovation document. This enables the digitizing and notarization of intellectual property records upon entering them into the system, so that when they are distributed, the integrity, content, and timestamp can be verified.

Moreover, by redundantly spreading the signed documents across multiple servers, the chances of an internal security breach are greatly reduced, and tampering of the documents in their native state is made more difficult. In the event of security breach or claimed theft of intellectual property, information may be extracted from the redundant documents stored on remote transactional servers and compared with the primary innovation record to determine if any part of any of the files have been tampered with or altered. The redundant comparison of point-of-transaction documents guarantees authenticity and provides protection against single source tampering of data as a means to compromise the integrity of the document.

As shown in block 46 of FIG. 4, once the innovation profile has been compiled, program logic within the innovation marketplace server may parse the innovation profile and create two or more sub-profiles corresponding to varying levels of disclosure. It will be appreciated that any number of sub-profiles may be created, with each sub-profile containing a different level (or amount) of information concerning the innovation. At a minimum, however, the innovation profile should be divided into at least two sub-profiles. For purposes of illustration only, the following example assumes that the innovation profile is divided into three distinct levels of disclosure corresponding to a different sub-profile. In this example, the level-one profile may contain only general details concerning the innovation such as the particular market that the innovation is directed to, the size of the marketplace, and an overview of the innovation. The purpose of the level-one profile is to provide enough information for the developers to determine whether the product innovation disclosed in the profile is of a type suited to their particular development needs and capabilities. The level-two profile preferably contains all of the information contained in the level-one profile, plus additional information related to the innovation that more specifically defines the innovation without fully disclosing all of the details. The level-two profile may include information such as more detailed market data, a portion of the innovator's profile information (i.e. the number of prior innovations, academic criteria, etc.), and more information concerning the actual innovation. Preferably, neither the level-one nor the level-two profiles contain sufficient data for the innovation to be implemented by a third party. The purpose of each profile is to provide information sufficient for the developers to make a determination as to whether the innovation is sufficiently suited to their need and capabilities without providing information sufficient to implement the invention. Advantageously, the lower-level profiles allow innovators to spark interest in their innovations without necessitating that they disclose details which would effectively surrender the innovation to the control of a third-party. This protects the innovator from losing control over their innovations by disclosing it to third parties prior to properly protecting the innovation. The level-three profile is preferably the full innovation profile containing all of the relevant information concerning the innovation. The level-three profile may also contain detailed information collected from the innovator's profile. Although the above example assumes that certain information may be included in the sub-profiles, the type and/or amount of information included in each sub-profile may be varied without altering the novel aspects of the present invention. Advantageously, the flexibility of the sub-profiles allows the present invention to be implemented in diverse fields of innovation by adapting the number of sub-profiles and the type and amount of information included therein.

As shown in block 48 of FIG. 4, the innovation sub-profiles are preferably stored in separate databases. The level-one and level-two profiles are preferably stored by the innovation marketplace server in separate databases. The level-one profiles are preferably stored in a database which is searchable by the product developers while the level-two profiles are preferably stored in a database that cannot be directly accessed by the product developers. To maintain the security of the level-three profile and protect it from inadvertent disclosure, the level-three profile may be stored offline in a separate database accessible by only a limited number of individuals or, alternatively, accessible only by the innovator. Product developers are given access to the level-three profile only offline and only after the innovator has given permission for full disclosure to occur.

The innovation sub-profiles enable the innovation marketplace server to match innovations with product developers suited to those innovations. This is accomplished using a tiered access system that is implemented as part of the new innovation marketplace. The tiered access system is described in detail below with reference to the developer's side of the new invention marketplace.

Developer-Side Services

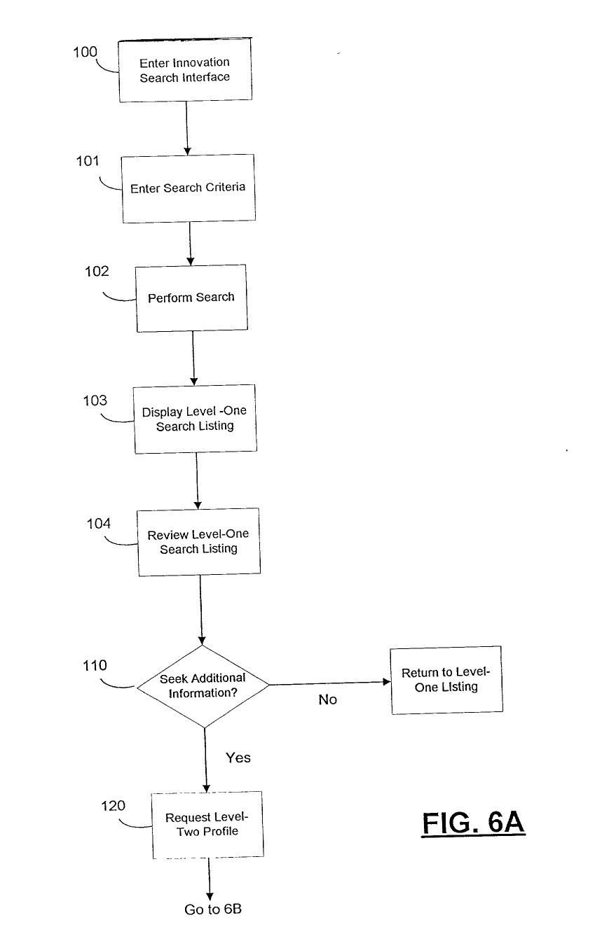

To understand the operation of the innovation marketplace and particularly the new innovation marketplace, it is useful to first describe the developer's role. The developer interface 14 may utilize any of several input/output devices to provide developers with access to the innovation marketplace services. Preferably, the interface may comprise a computer communicatively connected to the Internet. However, numerous other devices, such as phones, PDA's, facsimile machines, or local or wide area networks (LANs and WANs respectively), may also be used to provide access to the innovation marketplace server. The process by which the developers access the innovation marketplace server is shown in FIG. 5. The following discussion assumes that the developer accesses the innovation marketplace via an Internet-based interface. It will be appreciated, however, that similar access devices may be used without altering the novel aspects of the present invention.

The login and registration process according to one possible embodiment of the present invention will now be described with reference to FIGS. 1 and 4. As shown in block 60, the developer must first login to the innovation marketplace. This procedure is very similar to the login and verification process described above with respect to the innovator. Initially, the developer is presented with the developer interface that preferably displays a login screen transmitted to the developer interface by the innovation marketplace server. As shown in block 62, the innovation marketplace server 16 first determines whether the developer has established an developer profile. If the developer has not yet established a profile, the innovation marketplace server 16 presents the developer with an interface through which the developer can input the information sufficient to establish the developer profile. Preferably, the interface is an Internet web page containing a fillable template that requests information desired for inclusion in the developer profile such as: the identity of the developer, the developers demographic information, the market or markets in which the developer participates, the number of the developer's employees, the annual revenues of the developer, etc. The developer profile may also include information regarding the developer's credit information and the developer's preferred means of payment. The developer profile may also contain information concerning the developer's preferences regarding the types of innovations it is interested in and the characteristics of the innovators whose innovations it desires to review.

As with the innovator login process, the developer login process may also require that the developer enter into a legal agreement under which the developer agrees to certain conditions regarding its use of the innovation marketplace and the dissemination of the innovations contained therein. Preferably, the developer's rights and obligations under the agreement will be explained to the developer and the developer will be required to enter into the agreement before they are allowed to create the developer profile. Alternatively, the developer may be granted access to the system without having entered into the agreement, but the services that it is allowed to use may be restricted.

As represented by block 66, the innovation marketplace server 16 may verify the information provided by the developer by communicating with third-party databases such as Dunn & Bradstreet, Inc. If the identification server detects a discrepancy in the information, the developer may be asked to correct the error. In addition, the innovation marketplace server 16 may also supplement the information provided by the developer by adding additional information obtained from the third-party databases. If the developer is a company or organization containing more than one individual, the developer profile may also include a listing of specific persons within the developer's company or organization who have been given authorization to utilize the developer's accounts. In this embodiment, each individual within the developer's organization may be assigned a separate sub-account that contains additional information about each respective individual.

The identification server preferably assigns the developer unique and secure login information such as a login id and password. The particular type of login information used may vary according to the means by which the developer accesses the system. After a developer profile has been created and the developer has been assigned unique identification information, the developer may log into the innovation marketplace by inputting the developer's identification information into the developer interface, as represented by block 68. The identification information is then transmitted to the identification server that verifies the developer's information as represented by block 69. If the identification information matches a known developer profile, the developer is provided access to its respective developer account as shown in block 70. The means used to input the information may be any of numerous methods but is preferably done by entering information into the developer interface by filling out an Internet-based web form and submitting the information to the innovation marketplace server over the internet.

At this point, the developer is provided with an account interface (preferably an Internet web page) that lists numerous types of available information sources and provides links to developer services offered by the innovation marketplace. Preferably, the developer's account interface provides information such as: a summary of demographic information regarding the developer and/or its employees or affiliates; links to the latest news related to the developer; a listing of the names and/or the number of the representatives of the developer that are authorized to use the system; a link to the companies innovation profile searching criteria; information regarding the operation of the innovation marketplace, the services offered, and the development process; and contact information for the account manager responsible for the developer's account. The developer's account interface may also include information concerning the number of users (both developers and innovators) currently using the system, the number of successful transactions the developer has completed, links to all of the innovation profiles the developer has viewed in the past and/or updates regarding status changes to innovation profiles that the developer has expressed interest in, etc.

The developer account interface may also serve as the gateway to the developer services offered by the innovation marketplace. These services may include any service that enhances the development and marketing of innovations and makes it easier for the developers to identify and develop new innovations of interest to them. The following discussion will briefly describe several of the services that may be offered. It will be appreciated however, that the services described below are intended to be merely exemplary and are not intended to constitute all of the services that may be offered.

New Innovation Marketplace (Developer's Side)

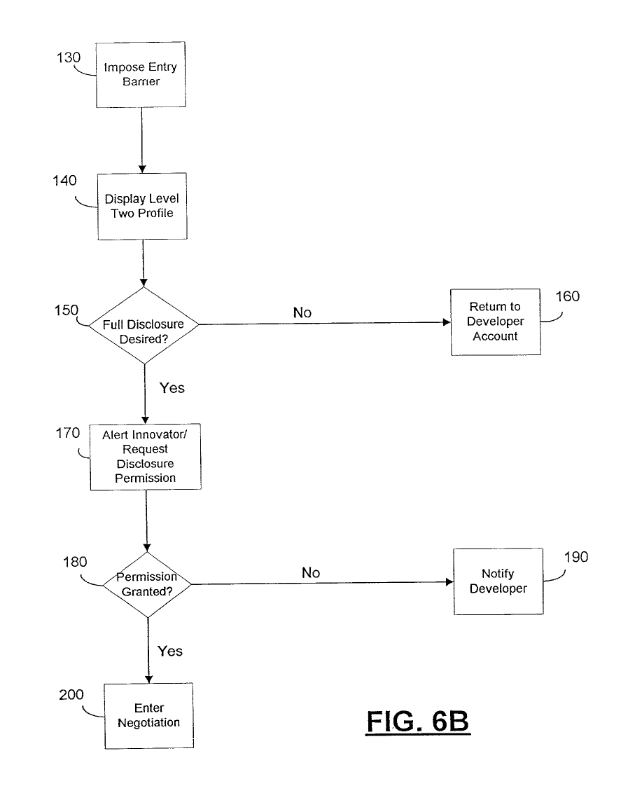

According to one aspect of the invention, the developers may access the new innovation marketplace. This service enables the developers to search the database of innovations entered by the innovators to identify innovations suited to its particular interests and expertise. In particular, the new innovation marketplace comprises a searchable database consisting of the level-one innovation profiles entered by the innovators. As shown in block 100 of FIG. 6A, the developer must first enter the new innovation marketplace. This may be accomplished by following a link from the developer's account interface. Upon entering the new innovation marketplace, the developer may be presented with an interface providing options available in the new innovation marketplace. The interface preferably consists of an Internet web page that allows the developer to enter a series of search criteria defining the type of innovations in which they are interested. Advantageously, the developer profile may already contain most of the information concerning the developers capabilities, preferences, etc. and thus the search form may be pre-filled by the innovation marketplace server with default values corresponding to the information contained in the developer's profile. The developer may also elect to change the search criteria and/or add new criteria to better define the types of innovation searched for. This information may optionally be used to update the developer profile. After the search criteria have been entered as shown in block 101, the innovation marketplace server performs a search of the level-one innovation profile database to determine whether any of the innovation profiles match the search criteria provided by the developer (illustrated by block 102). The innovation marketplace server may then prepare a listing of each of the innovation profiles that match the developer's search criteria and display the search listing to the developer via the developer interface, as shown in block 103. The developer may then review the level-one profiles returned by the search to determine whether any of the innovations outlined therein match the developer's development interests and/or capabilities, as shown in block 104. As illustrated by block 110, if the developer determines that a particular innovation profile fits the type of innovation and/or market opportunity that the developer is seeking, the developer may request disclosure of the level-two innovation profile for that innovation (as illustrated by block 115) to gain more information about the innovation. The level-two profile enables the developer to make a more informed decision as to whether it is wise to pursue developing the innovation. If the developer elects not to seek additional information, he may return to the level-one search listing.

Turning now to FIG. 6B, in order to prevent the developer from carelessly mining numerous innovation profiles or from trying to discern the details of a particular innovation without the innovator's permission, the innovation marketplace places an entry barrier on the disclosure of the level-two profiles, as illustrated by block 130. Typically the entry barrier will constitute a preset access fee that the developer must pay prior to granting access to the level-two innovation profile. Advantageously, the developer may set up an account with the innovation marketplace server such that the access fee is automatically debited from the account when the developer requests the level-two profile. An independent billing system may also be employed to facilitate collection of the access fee.

If the developer agrees to satisfy the entry barrier (i.e. pay the access fee), the innovation marketplace server displays the level-two innovation profile for the requested innovation on the developer interface as shown in block 140. The developer may review the level-two innovation profile to determine whether the innovation is still the type of innovation that the developer is interested in developing. Advantageously, the innovation remains protected because the details of the innovation, such as the exact market need it addresses and the particular solution it provides, are not fully disclosed. This provides the innovators with the assurance that their innovations will not be disclosed without their permission. As shown by block 150, if the developer desires full-disclosure of the invention, the innovator must agree to permit the disclosure. As shown in block 170, this may be accomplished by sending an alert to the innovator requesting permission to disclose the innovation. The alert preferably contains information regarding the developer such as its size, number of employees, production capacity, etc. This information may be automatically compiled from the developer profile by the innovation marketplace server. As is shown by block 180, if the developer agrees to permit full-disclosure of the innovation, the innovation marketplace server notifies the developer that its request has been granted. If the innovator refuses to grant full disclosure, the developer is notified of the refusal as shown in block 190. Notification may be achieved by any of numerous methods such as an electronic mail message, posting to the developer's account, telephone call, numerical paging, etc.

Advantageously, the innovation marketplace server has now fulfilled its role of matching a developer with an innovator. To ensure that the innovation is not inadvertently disclosed, full disclosure preferably occurs offline through a negotiation process. In a preferred embodiment, a meeting is arranged between the innovator and the developer and presided over by one or more representatives of the innovation marketplace. Thus, if the innovator elects to grant full-disclosure in block 180, the innovation marketplace server may alert both the innovator and the developer that a representative of the innovation marketplace will be contacting each entity to arrange a meeting to discuss the terms of the disclosure. The innovation marketplace server may also notify an innovation marketplace representative that a meeting needs to be arranged. If suitable terms are negotiated at the meeting, the level-three (or full-disclosure) is retrieved from offline storage and transferred to the developer's account where it may be stored. Alternatively, the level-three profile may be extracted from offline storage manually and presented to the developer in print form or on a diskette or other storage medium.

Alternatively, the innovation marketplace may facilitate an electronic exchange of information between the innovator and the developer. This may be accomplished using program logic that defines a set of XML specifications designed to provide an innovation marketplace business framework for the exchange of intellectual property and/or knowledge capital. Advantageously, by defining an XML framework, enterprises of any size and geographical location can meet, exchange intellectual property, and conduct business with each other through the exchange of XML-based documents and messages.

Preferably, the innovation marketplace will integrate a SOAP (Simple Object Access Protocol) and SOAP with Attachments specification protocol into the XML framework. SOAP is a lightweight protocol for exchange of information in a decentralized, distributed environment. It will be appreciated that this structure will facilitate an open and widely adoptable global standard for reliable exchange of reliably transporting intellectual property business documents over the Internet. The XML structure will also preferably encompass services and protocols that allow a developer to request services from the innovation marketplace servers over any application-level transport protocol, such as SMTP, HTTP and others. In addition, the XML structure preferably provides the flexibility to define a general-purpose innovation concept and may include a header that supports categories and sub-categories (classifications and sub-classifications), while allowing digital signatures to be embedded at key points within the message body. The XML structure also preferably enables content containing textual and binary data in may formats (ex: XML, MIME or digital data in base 64 encoding). It will be appreciated, however, that other formats, types, and/or features of electronic data interchange may also be implemented as part of the innovation marketplace without altering the novel aspects of the present invention.

It will be appreciated by those of skill in the art that the new innovation marketplace provides a secure method for innovators to market their innovations to developers without forfeiting the rights owned in their innovations. It will also be appreciated that the new innovation marketplace provides developers with an efficient means for searching for new innovations suited to their development capabilities.

Innovation Alerts

Numerous additional features may also provided to aid the developers in searching for new innovations and innovators interested in developing new innovations. For example, the developer's account may provide access to an innovation alert service that enables the developer to create one or more unique search filters that are used by the innovation marketplace server to filter each new innovation that is placed into the system by an innovator. If a new innovation profile matching one of the unique profiles is posted into the new innovation marketplace, the innovation marketplace server may notify the developer and/or a particular contact person identified in the unique search filter. The notification could also alert the developer if a previously viewed profile is changed or updated. The notification may also include a link to the level-one innovation profile as well as the time and date that the profile was entered or updated. Notification may be achieved using any of several known messaging methods such as electronic mail or by posting the notification into the developer's account interface.

Survey Services

According to another aspect of the present invention, the innovation marketplace may also enable developers to conduct targeted research using electronic surveys directed toward a particular market segment or group of innovators. The survey services are preferably provided as part of the services offered to the developers from the developer account interface. In one embodiment, the developer account interface may provide a link to a separate web page (or other interface) that enables the developer to select from a list of pre-formatted surveys and/or customize their own survey for a particular purpose.

Numerous types of surveys may be utilized to collect information regarding various market trends and product developments. For example, a developer may wish to conduct a product refinement survey that solicits information regarding a particular product. Advantageously, the innovation marketplace enables the developer to enter information regarding its customer base into its respective developer profile. In this embodiment, the developer may provide information regarding its customer base and/or individual customers to the innovation marketplace server. The innovation marketplace server may then store this information and independently alert each of the developer's customers that they are invited to join the innovation marketplace and participate in the product refinement process (or one of the other services provided by the innovation marketplace).

Alternatively, the survey may target innovators already participating in the innovation marketplace that fit specified demographic criteria and/or other specifications or requirements. Companies may be allowed to specific criteria for survey participants and the innovation marketplace may include program logic which automatically disperses the survey to a group of participants that meet the specified criteria by comparing the criteria with information contained in the innovator profile. The innovator participant may then be alerted that they have been chosen to participate in a particular survey through email, fax, phone, or by posting an alert to the innovator interface. Preferably, the innovator is alerted using a method specified by the innovator as his or her preferred method.

The innovator may also be able to learn more about the survey opportunity by accessing a link provided on the innovator interface. This link may provide the innovator with a brief description of the type of survey, the approximate time to complete the form, and the compensation for participating. If they choose to participate, the completed survey may also be bound with an anonymous summary of the participant (preferably compiled from information in the innovator profile).

Advantageously, each survey may be refined by the developer to target particular innovators that possess the most pertinent information. It will be appreciated that the innovation marketplace enables the developers to automatically target specific types of innovators and/or market participants without requiring excessive information or additional labor because the majority of the information required is already stored in the innovator and developer profiles.

A survey may also be utilized to conduct qualitative or quantitative market research The developer may customize these surveys by specifying the qualifications required to participate such as general or specific demographic information, certifications, practice areas, academic background, etc. Advantageously, the innovation marketplace server may automatically direct the survey to those innovators whose innovation profiles meet the required qualifications. The innovation marketplace server may also automatically verify that any innovators completing the survey satisfy the predefined participation criteria. Each of the above survey examples also preferably contain information regarding the approximate time required to complete the survey and/or information regarding potential payments or incentives provided by the developer in return for completion of the survey.

Surveys may also be employed to collect information regarding innovations within the innovation marketplace such as trends in innovation, types of innovations being transacted (i.e., those innovations that have been successfully marketed to developers), types of innovators participating in the innovation marketplace, etc. In this embodiment, the innovation marketplace server may conduct the survey internally without transmitting the survey to the innovators. It will be appreciated that the innovators may also submit surveys directed to trends in the innovation marketplace, types of developers, recent transactions, etc.

Reverse Innovation Query

According to another aspect of the present invention, the innovation marketplace may also enable the developer to submit a reverse innovation query. The reverse innovation query generally enables the developer to request innovation profiles that fit the developer's needs. The reverse innovation query is particularly useful when the developer is unable to locate an innovation profile in the new innovation marketplace that fits its needs and capabilities. Advantageously, the developer may request a particular type of innovation and/or group of innovations that fits its needs using the reverse innovation query. The reverse innovation query may comprise: information regarding the relevant market (or market segment); information regarding the type of machine or mechanism (e.g. tools, diagnostic equipment, electromechanical devices, etc.); the demographics of potential innovators; the demographics of the developer submitting the query; information regarding the materials to be used; regulatory information; and information regarding the specific problem to be addressed and the level of involvement the innovator will have in the development process.

After the developer has composed the reverse innovation query, the innovation marketplace server may post the query to the innovator account interfaces of the innovators matching the innovator demographic criteria contained in the query. The innovation marketplace server may also save the reverse innovation query into a database that is searchable by the innovators (and preferably available on the innovator interface); thus enabling innovators to search for (and locate) reverse innovation queries matching their capabilities or expertise. Advantageously, the reverse innovation query provides developers with a means for specifying desired products while providing innovators with a means for searching for new innovation ideas for which a demand already exists. If an innovator chooses to pursue the innovation identified in the reverse innovation query, the innovator may be directed to the new innovation marketplace and asked to construct a new innovation profile. The innovation marketplace server may also complete much of the information for the innovation profile by parsing the reverse innovation query and pre-filling the new innovation profile form with information taken from the reverse innovation query.

Existing Product Refinement

According to another aspect of the present invention, the innovator may create an innovation profile directed towards an improvement to an existing product. The process for creating an innovation profile for a product improvement is generally the same as the process for creating a new innovation profile. However, the innovation marketplace server may provide a separate template for use with product improvements which reduces the requested information. After the improved product innovation profile is completed, the innovation marketplace preferably determines the owner of the product which is the subject of the improvement. In a preferred embodiment, the innovation marketplace server also contains program logic capable of searching third-party databases to determine the owner of a particular product. If the owner is a developer or innovator subscribed to the innovation marketplace, the innovation marketplace server may transmit a notification to the company alerting it that an improvement for one of its products has been posted to the system. The notification may also include a reference to the level-one innovation profile for the improvement. If the developer is interested in learning more about the improvement, the process may continue as described above with the developer requesting the level-two profile and, if desired, full disclosure following a negotiation between the parties.

Ancillary and Value-Added Services

According to another aspect of the present invention, the innovation marketplace may also provide innovators and developers with access to numerous ancillary services that may be utilized to aid in the development process and add value to an innovation. For example, the innovation marketplace may also comprise an innovation community that is accessible by both the innovators and/or the developers. The innovation community may comprise a bulletin board system (BBS) or an interactive chat room that provides a forum for innovation related discussion. In particular, the innovation community may comprise forums relating to common development problems, innovation partnering opportunities, improvements to the innovation marketplace, or any other forum that facilitates innovation and/or product development. The innovation community may also provide an informal forum wherein developers may request solutions to particular problems and/or wherein innovators may seek the advice of other innovators regarding a particular problem. The innovation community may also comprise certain forums wherein access is restricted to innovators and/or developers meeting predefined access criteria.

The innovation marketplace may also provide access to third-party services pertaining to innovation marketing and development. For example, the innovation marketplace may partner with third-party service providers to provide ancillary services and/or information. The third-party service providers may provide any of numerous services such as design services, marketing services, manufacturing and materials consulting services, business development services, venture financing services, funding management services, engineering services, regulatory consulting services, legal services, etc. In one embodiment, one of more of the ancillary services may be incorporated into the innovation marketplace such that information obtained from these services is automatically added to one of more of the innovation profile, innovator profile, or developer profile. For example, if an innovator contacts a third-party regulatory consulting firm to determine whether a particular innovation meets certain regulations, the information provided by the third-party consultant may be added to the innovation profile. Thus, any value building service provided by a third party vendor may be added to the innovation profile for a particular innovation. In this manner, the innovation profile may be automatically updated as new information is obtained.

Dynamic Product Feedback

According to another aspect of the present invention, the innovation marketplace may provide developers and/or innovators with the ability to automatically input information concerning particular innovations into the innovation marketplace using wireless product sensing packages (WPSP). The WPSPs may be installed in (or on) a product at the time of manufacture or assembly. The WPSPs are preferably capable of harvesting real time product usage information from the actual product such as product applications, usage information, information concerning the environment in which the product is used, the number of product uses (or the period of use), and information concerning the product's current condition. In a preferred embodiment, this information is collected by the WP)SPs and transmitted to an input interface connected to the innovation marketplace server. Alternatively, the information is harvested and transmitted to a separate database in communication with the innovation marketplace server. The information may then be stored and analyzed to determine actual product usage information over the life of the product. Advantageously, this enables product manufacturers to harvest product information directly from the product and use that information to determine ways to improve the product in the future.

Consumer Idea Harvesting

According to another aspect of the present invention, the innovation marketplace may be equipped with means for automatically harvesting, compiling and analyzing consumer usage data. This may be achieved by partnering with developers to direct product consumers to the innovation marketplace. In a preferred embodiment, consumers may be provided with a separate interface similar to the innovator and developer interfaces. Consumers may be asked to input information relating to product usage, consumer concerns, product drawbacks, preferred features, and suggested improvements. Advantageously, consumers who are directed to the innovation marketplace may also be allowed to input information concerning related products or other products of interest. It will be appreciated that such direct consumer feedback may enable developers to design products better suited to consumer demands and preferences.

Stream of Consciousness Innovation

Another aspect of the present invention is the ability to adapt the innovation marketplace to take advantage of technological advances in other fields relating to the collection and transfer of data. Thus, the innovator and developer interfaces may be adapted such that information is input into the system from diverse devices such as PDAs and facsimile machines. As new methods for collecting and transmitting information become available, the innovator and developer interfaces may be adapted to allow users to input information more efficiently. For example, user may be provided with an input device which enables them to input their thoughts immediately using a handheld or mobile device.

Knowledge Capital Harvesting and Dissemination

According to another aspect of the present invention, the innovation marketplace may include means for collecting knowledge capital from a plurality of individuals within a particular organization or company. In this embodiment, knowledge capital may be harvested over time via email questionnaire, video demonstrations, personal interviews, written interviews, or virtual shadowing (hardware follows subject throughout a day, recording the process(es) real time). The innovation marketplace server would then catalogue the harvested data and store it for the third party. Advantageously, large companies may use this service to manage a dynamic, value-added “idea box” that not only feeds corporate growth and development but also has the potential to generate revenue outside the company. In addition, if a company determines that a particular innovation is worthy of development, the company may then submit the innovation into the innovation marketplace for further refinement and development.

Innovation Evaluation Services

According to another aspect of the invention, the innovation marketplace may facilitate the marketing of a new innovation by forecasting various development options and the feasibility of marketing an innovations to various potential target audiences. This may be accomplished by enabling an innovator to create a series of “idea-maps” that provide various alternatives for obtaining a marketable product. The resulting products may then be compared to market demographics and research information to help determine the feasibility of marketing the idea to various target audiences and business entities. This process enables innovators to learn how to market their ideas and services more effectively by the buying market demographics of the innovation marketplace. Also, this analysis helps to provide on-going support, encouragement, and marketing opportunities for innovation marketers worldwide. This feature of the innovation marketplace provides advantages to innovators because they can logically display all of the information necessary to properly analyze an innovation marketing strategy, all of which can be accomplished with the limited budgets typical of innovators due to the innovation marketplaces economies of scale.

Many modifications and other embodiments of the invention will come to mind to one skilled in the art to which this invention pertains having the benefit of the teachings presented in the foregoing descriptions and the associated drawings. Therefor, it is to be understood that the invention is not limited to the specific embodiments disclosed and that modifications and other embodiments are intended to be included within the scope of the appended claims. Although specific terms are employed herein, they are used in a generic and descriptive sense only and not for purpose of limitation.

That which is claimed:

1. In an innovation marketplace comprising an innovator interface, a developer interface, and an innovation marketplace server, each of which is communicatively connected to a network, a method for dynamically matching knowledge capital with developers capable of developing the knowledge capital comprising:
receiving knowledge capital information at the innovation marketplace server from at least two innovator interfaces defining a plurality of innovation profiles;
dividing each of the plurality of innovation profiles into at least two sub-profiles wherein a first sub-profile comprises a first level of information and a second sub-profile comprises a second more comprehensive level of information;
storing the sub-profiles in at least one database associated with the innovation marketplace server;
searching the database to determine if one or more of the first sub-profiles matches a predefined search criteria;
displaying at least one first sub-profile in response to a match between the at least one first sub-profile and a search criteria provided by a developer; and
providing access to the second sub-profile corresponding to the at least one first sub-profile in response to the satisfaction of an access barrier.

2. The method of claim 1, wherein receiving knowledge capital information from at least two innovator interfaces defining a plurality of innovation profiles comprises receiving information identifying an innovator of the knowledge capital.

3. The method of claim 2, further comprising verifying the identity of the innovator of the knowledge capital using information obtained from a database remote from the innovation marketplace server.

4. The method of claim 1, wherein storing the sub-profiles in a database comprises storing the first sub-profile in a first database and the second sub-profile in a second database.

5. The method of claim 1, wherein receiving knowledge capital information from at least two innovator interfaces defining a plurality of innovation profiles includes associating a time and date stamp with the knowledge capital information indicating the date and time the knowledge capital information was received.

6. The method of claim 5, further comprising receiving additional knowledge capital information from at least one innovator interface, storing the additional knowledge capital information in one of the plurality of innovation profiles, and associating a different date and time stamp with the additional information indicating when the additional information was added to the innovation profile.

7. The method of claim 5, further comprising storing the knowledge capital information including the associated time and date stamp on at least one server remote from the innovation marketplace server.

8. The method of claim 1, wherein receiving knowledge capital information from at least two innovator interfaces defining a plurality of innovation profiles includes receiving knowledge capital information comprising a unique digital signature indicating the author of the knowledge capital information.

9. The method of claim 1, wherein providing access to the second sub-profile corresponding to the at least one first sub-profile in response to the satisfaction of an access barrier comprises providing access to the second sub-profile in response to the payment of a monetary amount.

10. The method of claim 1, wherein providing access to the second sub-profile corresponding to the at least one first sub-profile in response to the satisfaction of an access barrier comprises providing access to the second sub-profile in response to a developer entering into a contractual obligation with the innovator.

11. A system for dynamically matching knowledge capital with developers capable of developing the knowledge capital comprising:
an innovator interface;
a developer interface;
a network; and
an innovation marketplace server wherein the innovation marketplace server is communicatively connected to the innovator interface and the developer interface through the network and;
wherein the innovation marketplace server: receives knowledge capital information from the innovator interface defining a plurality of innovation profiles; divides each of the plurality of innovation profiles into at least two sub-profiles wherein a first sub-profile comprises a first level of information and a second sub-profile comprises a second level of information; stores the sub-profiles in at least one database associated with the innovation marketplace server; searches the database to determine if one or more of the first sub-profiles matches a search criteria defined by information received from the developer interface; displays at least one first sub-profile in response to a match between the at least one first sub-profile and the search criteria; and provides the developer interface with access to the second sub-profile corresponding to the at least one first sub-profile in response to the satisfaction of an access barrier based on input received from the developer interface.

12. The system of claim 11, wherein the innovation marketplace server receives knowledge capital information from at least two innovator interfaces defining a plurality of innovation profiles comprising information identifying a innovator of the knowledge capital.

13. The system of claim 11, wherein the innovation marketplace server further verifies the identity of the innovator of the knowledge capital using information obtained from a database remote from the innovation marketplace server.

14. The system of claim 11, wherein the innovation marketplace server stores the first sub-profile in a first database and the second sub-profile in a second database.

15. The system of claim 11, wherein the knowledge capital information received by the innovation marketplace server comprises a time and date stamp associated with the knowledge capital information indicating the date and time the knowledge capital information was received.

16. The system of claim 15, wherein the innovation marketplace server receives additional knowledge capital information from at least one innovator interface, stores the additional information in one of the plurality of innovation profiles, and associates a date and time stamp with the additional information indicating when the additional information was added to the innovation profile.

17. The system of claim 15, wherein the innovation marketplace server stores the knowledge capital information including the associated time and date stamp on at least one server remote from the innovation marketplace server.

18. The system of claim 11, wherein the innovation marketplace server receives knowledge capital information comprising a unique digital signature indicating the author of the knowledge capital information.

19. The system of claim 11, wherein the innovation marketplace server provides access to the second sub-profile corresponding to the at least one first sub-profile in response to the payment of a monetary amount.

20. The system of claim 11, wherein the innovation marketplace server provides access to the second sub-profile corresponding to the at least one first sub-profile in response to a developer entering into a contractual obligation with the innovator.
